(19) United States
(12) Patent Application Publication
(10) Pub. No.: US 2008/0236033 A1
(43) Pub. Date: Oct. 2, 2008

(54) Slow-release floating fertilizer

(76) Inventors: Yao Sun, Montgomery Village, MD (US); Sam Sun, (US)

Correspondence Address: YAO SUN, 18009 Royal Bonnet Circle, Montgomery Village, MD, 20886, US

(21) Appl. No.: 12/077,921

(22) Filed: Mar. 24, 2008

Related U.S. Application Data
(60) Provisional application No. 60/919,893, filed on Mar. 26, 2007.

(51) Int. Cl. A01G 7/00; C01B 25/00; C01B 21/00; C01B 35/02; C05D 5/00; C05D 9/00

(52) U.S. Cl. 47/1.4; 423/322; 423/351; 423/298; 420/513; 420/434; 420/469; 420/429

(57) ABSTRACT

Floating slow-release fertilizer is designed to significantly reduce carbon dioxide in the atmosphere. This granulated fertilizer has a density lighter than seawater. Therefore its pellets can float on the surface of seawater. After being dispensed into water, the pellets are able to continually release certain nutrients for a period of time. During this period, an otherwise inanimate water region is temporarily suitable for plant growth. Floating slow-release fertilizer enables the growth of planting phytoplankton in ocean to remove CO₂ from atmosphere. The advantages of the fertilizer are as following: all nature, effective, no byproduct, no land using, no pollution, using solar energy mainly, small investment, easy to control, low operation cast.

### BACKGROUND OF THE INVENTION

1. Field of the Invention

Scientists have concluded that our planet is warming, and we are helping make it happen by adding large amounts of heat-trapping gases, primarily carbon dioxide (CO2), to the atmosphere. Our combustion of fossil fuel is the main source of these gases. Every time we drive a car, use electricity from coal-fired power plants, or heat our homes with oil or natural gas, we release heat-trapping gases to the atmosphere. The burning of fossil fuel (oil, coal, and natural gas) alone accounts for about 75 percent of annual CO2 emissions from human activities. The second most important source of greenhouse gases is deforestation—the cutting and burning of forests that trap and store carbon—for about another 20 percent. The combustion is the process of breaking hydrocarbon molecules down to carbon dioxide and water in the presence of oxygen.

fossil fuel+oxygen===carbon dioxide+water+energy

Molecules can absorb and emit three kinds of energy: energy from the excitation of electrons, energy from rotational motion, and energy from vibrational motion. The first kind of energy is also exhibited by atoms, but the second and third are restricted to molecules. A molecule can rotate about its center of gravity (there are three mutually perpendicular axes through the center of gravity). Vibrational energy is gained and lost as the bonds between atoms expand and contract and bend. The three kinds of energy are associated with different portions of the spectrum: electronic energy is typically in the visible and ultraviolet portions of the spectrum (for example, wavelength of 1 micrometer), vibrational energy in the near infrared and infrared (for example, wavelength of 3 micrometers), and rotational energy in the far infrared to microwave (for example, wavelength of 100 micrometers). The specific wavelength of absorption and emission depends on the type of bond and the type of group of atoms within a molecule. What makes certain gases, such as carbon dioxide, act as “greenhouse” gases is that they happen to have vibrational modes that absorb energy in the infrared wavelengths at which the earth radiates energy to space. In fact, the measured “peaks” of infrared absorbance are often broadened because of the overlap of several electronic, rotational, and vibrational energies from the several-to-many atoms and interatomic bonds in the molecules. (Information from “Basic Principles of Chemistry” by Harry B. Gray and Gilbert P. Haight, Jr., published 1967 by W. A. Benjamin, Inc., New York and Amsterdam)

As the concentration of these gases grows, more heat is trapped by the atmosphere and less escapes back into space. This increase in trapped heat changes the climate, causing altered weather patterns that can bring unusually intense precipitation or dry spells and more severe storms. The IPCC's Third Assessment Report projects that the Earth's average surface temperature will increase between 2.5° and 10.4° F. (1.4°-5.8° C.) between 1990 and 2100 if no major efforts are undertaken to reduce the emissions of greenhouse gases. This is significantly higher than what the Panel predicted in 1995 (1.8°-6.3° F., or 1.0°-3.5° C.).

Since pre-industrial times, the atmospheric concentration of carbon dioxide has increased by 31 percent. Science tells us with increasing certainty that we are in for a serious long-term problem that will affect all of us. Scientists agree that if we “wait and see” for 10, 20, or 50 years, the problem will be much more difficult to address and the consequences for us will be that much more serious. The real losers here are our children and grandchildren, who, if we don't act soon, are going to inherit a planet that is not going to be as hospitable as the one we were given by our parents and grandparents

Scientists predict that even if we stopped emitting heat-trapping gases immediately, the climate would not stabilize for many decades because the gases we have already released into the atmosphere will stay there for years or even centuries. So while the warming may be lower or increase at a slower rate than predicted if we reduce emissions significantly, global temperatures cannot quickly return to today's averages.

There are about 775 billion tons of carbon dioxide in the atmosphere at any one time. Oceans store 50 times more carbon dioxide than the atmosphere as a gas and in the form of carbonate compounds (carbonates are polyatomic ions —CO₃). There is a balance between the carbon dioxide in the air of atmosphere and which in the water of ocean. When the atmospheric concentration of carbon dioxide increased, more carbon dioxide dissolved into the surface water of ocean and the ocean concentration of carbonate increased too.

Photosynthesis is the only way our planet can remove carbon dioxide and regenerate oxygen. It is reverse chemical reaction of respiration. Respiration is the process used by living cells to break down sugar molecules (glucose) that living things get when eating plants or animals. This breakdown involves oxygen and results in the production of energy, carbon dioxide and water:

glucose+oxygen===carbon dioxide+water+energy

This results in the production of usable energy and heat for the body. During photosynthesis the energy from sunlight, water and carbon dioxide are converted to food molecules (like glucose-sugar) and oxygen. Glucose is an organic molecule. The chemical reaction looks like this:

carbon dioxide+water+sunlight===glucose+oxygen

The balance of respiration and photosynthesis allows the amount of carbon dioxide in the atmosphere to remain constant. Recent decades our combustion of fossil fuel puts about extra 6.2 billion tons of carbon dioxide in the atmosphere each year and causes the atmosphere concentration of carbon dioxide increase.

Photosynthesis removes 101 billion tons of carbon dioxide from the air each year. That is about one seventh of the carbon dioxide in the atmosphere. Photosynthesis occurs in all green plants on the surface of the Earth and also in the algae (seaweed) and in phytoplankton (one-celled organisms) living near the surface of bodies of water (such as the ocean). The one-celled organisms that live near the surface of the oceans (near coasts and around the south pole) are called phytoplankton or just plankton. These small organisms consume the major portion (over ¾) of the carbon dioxide removed by photosynthesis. If we can plant 6% more plants, they will remove the 6.2 billion tons carbon dioxide released from our combustion of fossil fuel, and the atmospheric concentration of carbon dioxide will not increase any more. If we can plant more than 6% plants, the atmospheric concentration of carbon dioxide will decrease and our children and grandchildren may inherit a planet that will be very much a same one in pre-industrial times. If we are going to select something to plant, then the phytoplankton is the best choice.

The relationship between plankton growth and the availability of iron was first suggested in 1988 by revered Moss Landing Marine Base Labs oceanographer John Martin. In 1993, an area within the region of eastern equatorial Pacific Ocean was artificially enriched with a single dose of soluble iron to test whether phytoplankton are physiologically prevented from utilizing the available nutrients by the low natural iron concentrations and that was confirmed by Michael J. Behrenfeld*, Anthony J. Bale^{H}, Zbigniew S. Kolber*, James Aiken^{H} & Paul G. Falkowski* *Oceanographic and Atmospheric Sciences Division, Brookhaven National Laboratory, Upton, N.Y. 11973-5000, USA^{H}NERC Plymouth Marine Laboratory, Prospect Place, West Hoe, Plymouth PL1 3DH, UK

Mike Toner of Atlanta Journal-Constitution reported on Aug. 20, 2002 that satellite surveys had detected a sharp decline in plankton in several of the world's oceans. In a study reported in the August 8 issue of Geophysical Research Letters, the researchers compared sets of satellite data from early 1980 to the late 1990s. The data showed that the sharpest decreases in plankton were in the North Pacific and the North Atlantic, where their abundance decreased by 14 percent. It maybe because in the recent years less Gobi Desert dust storms in China, which belched iron dust into the air. The wind carried the dust across the Pacific, where it touched off temporary plankton blooms as it settled into the seas.

### DISCLOSURE OF THE INVENTION

### Summary of the Invention

The present invention relates to a novel method to convert carbon dioxide into oxygen and organic compounds by planting phytoplankton in water. The present invention also relates to a novel slow-release floating fertilizer for said phytoplankton planting. The slow-release floating fertilizer contains at least two parts: fertilizer and float. Said fertilizer contains the nutrients which are deficient in the area of seawater for the phytoplankton to grow. The nutrients in the particles of fertilizer will be in one of the forms: slightly-water-soluble compound covered by slow release film or water-soluble compound covered by slow release film or slightly-water-soluble compound without any cover. Said fertilizer contains at least one of the following nutrients: Nitrogen, Phosphorus, Iron, Boron, Manganese, Zinc, Copper and Molybdenum. Said float can be anything which density is less than seawater. The present invention also relates to a novel float which will become heavier than seawater after certain time by absorbing water or below certain temperature by shrinking of its volume and therefore it will sink into the bottom of seabed. The present invention also relates to a novel slow-release floating fertilizer for said phytoplankton planting which contains some seeds of preferred kind of phytoplankton.

### DESCRIPTION OF THE FIGURES

FIG. 1. The floating fertilizer on the surface of seawater.

FIG. 2. Porous floats absorbed said nutrient containing compounds with a density lighter than seawater.

FIG. 3. The float is covered by the nutrient containing compounds.

FIG. 4. The fertilizer particle containing said nutrient is covered by float.

FIG. 5. The fertilizer particle containing said nutrient is connected with a float or floats.

### DETAILED DESCRIPTION OF THE INVENTION

Phytoplankton planting is a very effective, economical and controllable way to reduce the atmospheric concentration of carbon dioxide. The effect of phytoplankton planning can be imagined by the fact: very small portion of surface of water of our planet is been using by phytoplankton and they are removing major part of carbon dioxide away from atmosphere. Phytoplanktons are minute, free-floating aquatic plants that live near the surface of the oceans close to coasts and around the South Pole. It contains the pigment chlorophyll, which is used by plants for photosynthesis. In photosynthesis sunlight is used as an energy source to fuse water molecules and carbon dioxide into carbohydrates. Phytoplankton use carbohydrates as “building blocks” to grow. The carbon dioxide in the atmosphere is in balance with Carbon dioxide in the ocean. During photosynthesis phytoplankton removes carbon dioxide from seawater, and release oxygen at the same time. This allows the oceans to absorb additional carbon dioxide from the atmosphere. The phytoplankton grows rapidly. Given populations of them can double its numbers on the order of once a day. They have short lifetime. Even in ideal conditions an individual phytoplankton only lives for about a day or two. When it dies, it sinks to the bottom. Consequently, over geological time, the ocean has become the primary storage sink for carbon. About 90 percent of the world's total carbon content has settled to the bottom of the ocean, primarily in the form of dead biomass.

Phytoplankton planning is very economical because we do not need to a lot of things which are necessary for planting on land, the only thing we need to do is fertilizing very small amount of life-sustaining nutrients which are not enough in the area. Like other plant, phytoplanktons need sunlight, water, and nutrients to grow. In the area far away from land with sunlight and water, phytoplankton cannot survive due to the absent of some life-sustaining nutrients. The essential nutrients in plants are divided into macronutrients and micronutrients by their amounts in plants. Macronutrients are: Oxygen, Carbon, Hydrogen, Nitrogen, Potassium, Calcium, Magnesium, Phosphorus and Sulfur. Phytoplankton in remote area may lack for Phosphorus but other essential Macronutrients nutrients. The amount of Phosphorus in plants is 0.2% of dry weight and Carbon is 45%. In other words, there is only one atom of Phosphorus for every 581 atoms of Carbon in dried plant material. It means that for every atom of Phosphorus fertilized in seawater may remove up to 581 molecules of carbon dioxide from the atmosphere. The Micronutrients are: Chlorine, Iron, Boron, Manganese, Zinc, Copper, and Molybdenum. The amount of any micronutrients in plants is less than 0.01% of dry weight. Fertilizing every atom of any Micronutrients in seawater may remove up to thousands molecules of carbon dioxide from the atmosphere. Planting phytoplankton by only fertilizing deficient nutrients in remote area of ocean to remove carbon dioxide from atmosphere is obviously much more economical than any other methods.

The phytoplankton planning is controllable by the amount of fertilizer distributed. As previously stated, in the remote area of ocean phytoplankton cannot survive due to the absent of some life-sustaining nutrients and an individual phytoplankton only lives for about a day or two. It is clear that as long as the supply of the necessary nutrients last, populations of this marine plant will grow and as soon as the necessary nutrients run out, there will be no phytoplankton any more. The bigger area fertilized with deficient nutrients, the larger the world's phytoplankton population, the longer the fertilizer lasts, the more carbon dioxide get pulled out from the atmosphere. From outer space, satellite sensors can distinguish even slight variations in color to which our eyes are not sensitive. Different shades of ocean color reveals the presence of differing concentrations of phytoplankton. With the information obtained by satellite and chemical analysis of seawater, the phytoplankton planning will be totally under control by means of fertilizing.

A special floating slow releasing fertilizer is the key of phytoplankton planning. As previously stated, phytoplankton require sunlight, water, and nutrients for growth. Because sunlight is most abundant at and near the sea surface, phytoplankton remains at or near the surface. There is almost no phytoplankton under 10 meter in seawater because of darkness. The water is usually over 5000 meter deep in remote area of the ocean. Using solvable fertilizer means to waste almost all of them because: First there are many kinds of chemicals in the seawater. The fertilizer may react with some chemicals in the seawater to form insoluble compound deposit upon the bottom of the seabed. Second, the remains will certainly defuse to everywhere no matter how deep the water is. Phytoplankton can only use the portion remains near the surface of water which may be only one part of hundreds or even less.

Using fine particles of slightly-water-soluble fertilize will only help a little bit. Of cause small particles fall down slower than bigger particles but they will fall down from very beginning when they are in the seawater. Besides, there are a lot of cations and ions in seawater, no matter how fine the particles of fertilize are, will no stable suspension be formed. Many rivers have muddy water that carries a lot of very fine particles of soil. The muddy water is a very stable suspension of soil in water. The fine soil particles suspended in the water carry a same kind electric charge. The same electric charge keep them repel each other to form bigger particles that makes the suspension stable. The electric charge will cancel out by cations or ions in seawater as soon as the muddy water pours into the sea and the fine particles will form bigger particles and settle down. As the same reason, fine particles of slightly-water-soluble fertilize will start to settle down as soon as they in seawater. Furthermore, the smaller the fertilizer particles are, the faster they defuse. It will not take long for most of them to move down 10 meters or more to the dark sea and they cannot be used by any plant any more. That is real “drop money into the water”. A floating slow releasing fertilizer will release nutrients gradually at a slow rate and continuously for a certain time. Most of them will be absorbed by phytoplankton before they defuse down into deep of seawater.

A particle of the floating slow releasing fertilizer is composted of at least of two parts: fertilizer and float. The part of fertilizer contains the nutrients, which are deficient in the area of seawater for the phytoplankton to grow. The nutrients in the particles of fertilizer will be either in a form of slightly water-soluble compound or covered by slow release film. Usually these fertilizer particles are heavier than seawater; therefore it is necessary to bond the fertilizer particle with a float to make the density of whole particle lighter than the seawater. The floating slow release fertilizer contains at least one of the following nutrients: Nitrogen, Phosphorus, Iron, Boron, Manganese, Zinc, Copper and Molybdenum.

A slow-release floating fertilizer for said phytoplankton planting also contains some seeds of preferred kind of phytoplankton.

The said float can be anything with a density less than seawater, such as air, active carbon, wax, perlite, vermiculite, sawdust and so on.

For special purpose some floats will become heavier after at least a week by absorbing water or below certain temperature by shrinking of its volume and therefore the density of the particle of fertilizer will become heavier than seawater and it will sink into the bottom of seabed.

The said floating slow release fertilizer may fall down into the following five kinds:

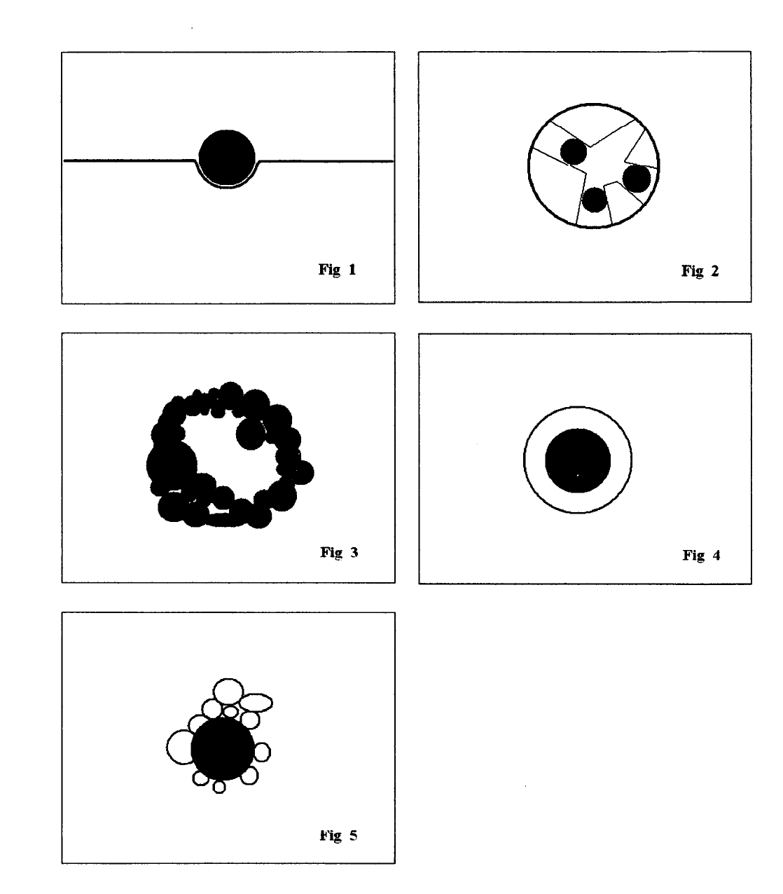

1. A grounded a slightly-water-soluble compound which contains at least one of the said nutrients with particle size so small that it can float by the surface tension. The particle size is preferred less than 0.1 mm in diameter. If the compound is non-polar or low polar molecule, the particles may stay on the surface of seawater by the surface tension of seawater. If the compound is polar or low polar molecule, coat the particles with non-polar or low polar molecule compound, such as wax, vegetable oil. Then the particles of the fertilizer will be able to float on the surface of seawater. (FIG. 1)

2. Porous floats absorbed said nutrient containing compounds with a density lighter than seawater. (FIG. 2)

3. The float is covered by the said nutrient containing compounds. (FIG. 3)

4. The fertilizer particle containing said nutrient is covered by float. (FIG. 4)

5. The fertilizer particle containing said nutrient is connected with a float or floats. (FIG. 5)

### VARIOUS EMBODIMENTS

The following embodiments of the present invention further illustrate the compositions of the slow-release floating fertilizer and are not intended to be limiting to the scope of the invention in any respect.

### First Embodiment

A synthetic slow-release fertilizer particle comprises crystalline phosphate having chemicals dispersed in the crystalline structure. The chemicals can comprise said nutrients in amounts suited for phytoplankton growth in certain area. A process for the preparation of a floating slow-release crystalline phosphate fertilizer is comprised of the following steps: (a) Prepare a solution (1) that contains said nutrients in amounts required for. (b) Mix the solution (1) with a phosphate solution, which contains enough phosphate ions to react with all the cation in the solution (1). (c) Adjust PH of the mixed solution to 7 or higher by adding basic chemical, such as Ca(OH)₂ Fe(OH)₃. (d) Separate the crystalline phosphate from the solution by filter. (e) The synthetic slow-release fertilizer then is dried at 150° C. (f) The fertilizer is ground to a powder, which has the particle size less than 400 mesh/In². (g) 5% wt. soybean oil is optionally added to the dried fertilizer. The fertilizer particle can optionally comprise a carbonate and/or silicon solubility control agent. The chemicals are released slowly as the fertilizer particle dissolves.

### Second Embodiment

Sawdust, plant material, vegetation, or agricultural waste can be used as a float in the slow-release floating fertilizer. The process is different for each kind of float material. The process of sawdust float, for example, is described as following steps: (a) Sieve the sawdust to keep the piece between 10-60 mesh. (b) treating said first a volume of sawdust with an equal volume of 2N (normal) nitric acid for 30 minutes at 121 degrees C. and 15 p.s.i. pressure to extract and solubilize the liqueurs material from the sawdust, (c) adding 1 volume of 1 normal solubilized sodium hydroxide to 2 volumes of said second volume of sawdust and heating and stirring said mixture until said nutrients are solubilized, (d) heating said second volume of sawdust and sodium hydroxide with steam and at a temperature of 121 degrees C. and pressure of 15 p.s.i. for 30 minutes to open the fibers of said sawdust, the fertilizer is deposit into the pores of sawdust by reaction from an organic acid having between 6 and 30 carbon atoms or phosphate acid and a metal oxide or carbonate. In a preferred embodiment, the sawdust is dried at 100°-300° C. completely, and then mixed with equal weight of 10% wt. phosphoric acid solution. After all the phosphoric acid solution is absorbed, each 100 kg wet phosphoric acid containing sawdust is mixed with 5 kg iron oxide powder, followed by a drying process at 100°-300° C. and coated with lignin derived from peanut hulls by solubilizing with 2N nitric acid. Optionally, the slow-release floating fertilizer is coating with at least one layer of rosin or paraffin. Said paraffin is selected from wax, heavy hydrocarbon residues and asphalts. The coating method enables to vary the rate of fertilizer release and the release period time according to specific requirements.

### Third Embodiment

Foaming is one method to make the slow-release floating fertilizer. The materials of foam can be any materials, which can form foam, such as plastic, protein, sugar and wheat flour. A selected fertilizer powder is mixed well with the selected foam material to form dough. The dough is cut into certain same size grains before bake. After baking the said grains spherical low-density foam pellets are obtained which contain the selected fertilizer. A dry process can reduce the density of the fertilizer containing foam pellets by evaporating remained solvent or water. The fertilizer containing foam pellets can be coated or encapsulated as described in example 4 and 5.

### Fourth Embodiment

One coating method for the manufacture of slow-release floating fertilizer is coating fertilizer pellets with at least one layer of an aqueous film forming latex. The coat of latex is coated on the fertilizer pellets directly. The coating process is conducted in series and the relative humidity of the air in the initial coating zones is maintained below the critical relative humidity of the pellet to be coated. The process provides a method to prepare coated pellets having an even coat. The density of the particles of the fertilizer and the fertilizer release rate depend on the density of the fertilizer pellets, the character of latex used, the thickness of the layer and the number of layers coated.

### Fifth Embodiment

An encapsulation is another method to make the slow-release floating fertilizer. The materials of encapsulate can be any water-insoluble or slightly water-soluble materials.

One kind of the materials of encapsulate is preferred that can be fused below the phase transition temperature of the fertilizer and the float if the float is encapsulated in with the fertilizer together. The preferred materials are but not limited to: thermoplastic resin, cellulose material, and latex.

### Sixth Embodiment

Perlite slow-release floating fertilizer can be made by the technique of ion exchange and coating. Here is an example of a process of an iron slow-release floating fertilizer: (a) A container filled with 80-120 mesh expended Na and K rich perlite particles is connected to a saturated FeCl₃ solution stream until no more Fe⁺³ can be taken by the perlite particles. (b) The iron exchanged perlite particles from step (a) are dried in a hot wind box and separated according its density. (c) The dried particles are mixed with a Fe₂O₃ contained Al(OH)₃ gel. Then go to step (b). (d) The particles with a density less than 1 are taken to step (c) and (b) again until their density reach 1. (f) The particles of said fertilizer with a density heavier than 1 are heated in an oven at 800° C. for 2 hours. In this process Al(OH)₃, Fe(OH)₃ and Fe(OH)₂ are converted to oxide.

We claim:

1. The method to remove carbon dioxide from atmosphere or to increase fishery resources by planting on sea using float slow-releasing fertilizer.

2. A float slow-releasing fertilizer which can float on water and release some essential nutrient for at least one week after being put into sea.

3. The fertilizer of claim 1 and the fertilizer of claim 2 can release at least one of the following nutrients: Nitrogen, Phosphorus, Iron, Boron, Manganese, Zinc, Copper, and Molybdenum.

4. The fertilizer of claim 3 will sink because the density of its particles become heavier than seawater after absorbing water for at least a week or at a temperature below 4° C. by shrinking of its volume.

5. The fertilizer of claim 3 contains some seeds of preferred kind of phytoplankton.
